(19) United States
(12) Patent Application Publication
(10) Pub. No.: US 2022/0312702 A1
(43) Pub. Date: Oct. 6, 2022

(54) A GROWING TRAY FOR A HYDROPONIC SYSTEM

(71) Applicant: NORDAMARK AB, SKÖVDE (SE)

(72) Inventor: Michael SKARET, SKÖVDE (SE)

(73) Assignee: NORDAMARK AB, SKÖVDE (SE)

(21) Appl. No.: 17/620,889

(22) PCT Filed: Jun. 25, 2020
(86) PCT No.: PCT/SE2020/050662

§ 371 Date: Dec. 20, 2021

(30) Foreign Application Priority Data
Jun. 28, 2019 (SE) 1950822-5

(51) Int. Cl. A01G 31/06; A01G 7/04; A01G 24/44

(52) U.S. Cl. CPC A01G 31/06; A01G 7/045; A01G 24/44

(57) ABSTRACT

The present disclosure relates to growing tray for a growth system, comprising a plurality of individual channels being distributed across a width of the growing tray and extending along a length of the growing tray. By means of the introduction of the channels it is possible to increase the yield of a crop to be grown at a growth substrate arranged on top of the channels. The present disclosure also relates to a growth system comprising a plurality of such growing trays.

### TECHNICAL FIELD

The present disclosure relates to growing tray for a growth system, preferably being a hydroponic system, comprising a plurality of individual channels being distributed across a width of the growing tray and extending along a length of the growing tray. By means of the introduction of the channels it is possible to increase the yield of a crop to be grown at a growth substrate arranged on top of the channels. The present disclosure also relates to a growth system comprising a plurality of such growing trays.

### BACKGROUND

Conventional growth of plants for human consumption, e.g. including lettuce, tomatoes, herbs, etc. is often performed indoors in greenhouses. Growing plants in greenhouses allows for the possibility of controlling the growth by monitoring the plant environment and controlling parameters such as light, water vapor pressure, temperature, CO₂ partial pressure, and air movement, in order to adjust the microclimate of the environment for optimizing growth and photosynthesis to improve plant yields.

To further improve plant yields it is possible to apply hydroponic gardening. Hydroponic gardening is a method of growing plants without soil using only mineral nutrient solutions in water. By means of indoor hydroponic gardening it may be possible to obtain end results without pesticides or agrochemicals, since any negative impact from the soil may be eliminated.

Recently there has been an urge to find plants that may further beneficial to the human body, having an increased nutrient content as compared to the above examples of plants. Sprouts, shoots, and microgreens have been identified as such possible plants, where microgreens have shown most promising. Microgreens are defined in the food trade as greens, lettuces and herbs which are harvested when quite young, generally when they are approximately 2-3 centimeters tall. Microgreens can have surprisingly intense flavors considering their small size and in a recent study, microgreens have been found to contain higher levels of nutrients than full sized greens and thus may be used to supplement a healthy diet on their own or to increase the healthful benefits of foods with which they may be combined.

Microgreens are used in a variety of ways, primarily in fine dining restaurants. They can be used as a fresh flavor accent to complement and enhance both the flavor and presentation of their dishes. Microgreens have a delicate, fresh appearance that adds beauty and dimension combined with a range of distinct flavor elements to a wide array of foods.

Microgreens have shown to be highly suitable for hydroponic gardening, and e.g. U.S. Pat. No. 8,910,419B1 shows an interesting approach to provide a suitably controlled environment for such growth. As disclosed in U.S. Pat. No. 8,910,419B1, a plurality of trays is provided and configured to fit onto a racking system. Each of the trays are provided with an essentially flat bottom surface to receive and be planted with seeds. In use, the trays allow for the capture of a maximum amount of water by the root mass of the greens, allowing growth at optimal rates, while also allowing drainage of maximal amounts of excess standing water under the root mass in the bottom of the trays that could potentially promote mold growth.

Unfortunately, the implementation of the trays as suggested in U.S. Pat. No. 8,910,419B1 has shown to be unsatisfactory, since water may be distributed unevenly due to the proposed drainage arrangement. As a result, the microgreens grow unevenly, and the risk of molds may be heightening in an unwanted manner.

Accordingly, in comparison to the presented trays of U.S. Pat. No. 8,910,419B1 and to other prior-art solutions, there would be desirable to provide further improvements as to ensure that the water within the tray is evenly distributed, in the end possibly increasing the overall yield of the microgreens.

Further attention is drawn to US2006112630, presenting a growth tray comprising multiple individual channel extending along the growth tray. A porous plant shoot support medium is placed fully within each of the individual channels.

### SUMMARY

According to an aspect of the present disclosure, the above is at least partly met by a growing tray for a growth system, preferably being a hydroponic system, the growing tray having an upwardly facing side and a downwardly facing side, wherein the growing tray has an elongated form extending along a length of the growing tray, a surface of the upwardly facing side is provided with a plurality of elongated independent channels having an upward facing protruding triangular cross section extending along the length of the growing tray, and the plurality of channels being distributed across a width of the growing tray, the width being perpendicular to the length of the growing tray, wherein upward facing protruding portions of the plurality of elongated independent channels are adapted to receive a layer of a growth substrate.

By means of the present disclosure, a plurality of elongated independent channels is provided and extends along the length of the growing tray. By means of the channels the layer of the growth substrate will not be provided flat to a bottom surface of the tray. Rather, any water entering the tray will typically flow from a first to a second end of the tray, ensuring that the water is distributed lengthwise along the tray while at the same time ensuring that the water is not, by the channels, distributed across the tray.

In accordance to the present disclosure, it will be further appreciated that, for convenience and clarity, relative terms such as “first” and “second” as well as spatial terms such as “vertical”, “horizontal”, “up”, and “down” may be used herein, e.g. with respect to the drawings.

As a comparison, in case of a tray comprising some forms of isolated protrusions to push the layer of the growth substrate up from the flat bottom surface (i.e. not extending along the length of the tray), such trays may e.g. dependent on an inclination of the tray end up with all water in one of the corners of the tray, rather than being evenly distributed throughout the length of the tray.

In line with the present disclosure, it has been shown to be surprisingly efficient to arrange the channels to have a triangularly based cross section in relation to the tray. The suggested triangular cross section has shown to allow for an improvement in an even distribution of water within the overall area of the tray as well as providing an improvement in root oxygenation, when the layer of the growth substrate covers essentially the overall width of the growth tray.

Typically, in line with the present disclosure the growth substrate is typically placed on top of the upward facing protruding portions formed by the plurality of elongated channels having the triangularly based cross section. Accordingly, the growth substrate arranged onto the protruding portions of the individual channels may be compared when a human body is arranged onto a “bed of nails”. That is, the body as well as the growth substrate will generally (upon positioning) not be spiked by the nails/protruding portions. Rather, the body/growth substrate will remain on top of the nails/ protruding portions.

Accordingly, advantages following the proposed solution for example lie in the possibility of ensuring that the total tray is provided with an even amount of water, even in case of a slightly crosswise inclination of the tray. Thus, by means of the present disclosure it may be possible to increase the yield of the crop grown at the tray while at the same time reducing the risk of unwanted “wet or dry spots” within an overall area of the tray as arranged in relation to the growth substrate.

In a preferred embodiment of the present disclosure the channels extend along a full length of the growing tray. Accordingly, in case e.g. the water is introduced at the first end of the tray it may be allowed to be distributed throughout the total length of the tray all the way to the second end of the tray.

Preferably, the channels are evenly distributed across the width of the growing tray. As such, the water provided at the tray will correspondingly have an increase possibility of ensuring the desired even distribution over the overall area of the tray.

It may in line with the present disclosure be desirable to arrange the channels to have a distance between a top of the channels to a bottom of the channels that is within the range of 0.1-5 cm, preferably within the range of 0.5-2 cm. As such, the distance is kept in comparison small enough such that the typically single layer of the growth substrate covering the width of the growth tray is easily contacted with the water arranged at the bottom of the channels. In addition, if the distance between the top of the channels and the bottom of the channels is increased “too much”, then any roots extending through a bottom surface of the layer of the growth substrate may be “hanging loose” in the volume formed between the bottom surface of the layer of the growth substrate and the bottom of the channels.

Accordingly, in some embodiments it may be possible to allow the distance between the top and the bottom of the channels to be selected depending on at least one of a crop to be grown at the growth substrate or a selected type of the growth substrate. That is, for example an average expected length of the roots may be used as an indication of the distance to be used in relation to the channels.

In a preferred embodiment of the present disclosure the growing tray further comprises a pair of side walls extending along the length of the growing tray. Such side walls ensure that the layer of the growth substrate stays within the tray, not sliding of the tray.

Preferably, the side walls upwardly protrude less than 5 cm from the surface of the upwardly facing side.

In addition to the above, it may in some embodiments of the present disclosure be desirable to select the downwardly facing side of the tray to be essentially flat. In combination with the side walls and possibly a pair of protrusions from the downwardly facing side of the tray, a plurality of trays may be arranged on top of each other in a stacked manner. The “stackability” of the tray(s) allows for an improved overall operational handling of the tray(s).

Preferably, the width of the growing tray is selected to be less than a fifth of the length of the growing tray, possibly in a range of 8-20 cm, preferably 10-15 cm. The length of the growing tray may correspondingly be selected to be within the range of 0.5-2 m in a typical implementation. As such, the tray or stack of trays are easily handled by a person e.g. lifting and/or carrying the tray(s).

In a preferred embodiment of the present disclosure the growth system is adapted for horizontal arrangement of the growing trays. As such, the tray is preferably adapted to be arranged to fit onto a racking system or on e.g. a shelf of the growth system. In case of using said racking system it may be desirable to provide the tray with means for ensuring that the tray slid and stay at the racking system.

It should be emphasized that horizontal arrangement of the growing trays should be interpreted broadly. As such, the trays may in some embodiments be arranged completely flat of a surface (more or less exactly horizontal in a cross and lengthwise manner) or somewhat slightly inclined in a lengthwise direction of the growing tray. If slightly inclined, the growing tray may for example be arranged to have an overall inclination of 0.0-5.0 degrees. The growing tray in themselves should be seen as generally “straight”, of course depending on an inherent weight of the growing tray, a length of the growing tray, the substrate, the crop and how the growing trays are arranged, etc.

It is advantageously to allow the growth system to be a hydroponic system and the layer of growth substrate to be a fiber mat, such as a hemp mat and/or preferably adapted for growth of microgreens. Preferably a single fiber mat may be used for covering the total growth area of the growing tray. Using a fiber (e.g. hemp) mat has shown promising both from an operational perspective and for increasing the yield of the end product. In regards to the operational perspective, the mat may be in comparison speedier positioned at the tray as compared to using soil. However, it should be understood that the concept in line with the present disclosure also may be used where the layer of growth substrate comprises soil. Accordingly, the growing tray according to the present disclosure is not necessarily limited to a hydroponic implementation, i.e. where no soil is used.

Preferably the growing tray is manufactured from a plastic material. Using a plastic material may decrease the weight as compared to metal or wooden material. Furthermore, by using plastic it may be in comparison easier to clean the tray in between crops. Also, a plastic tray may be easily manufacture, e.g. by means of injection molding or plastic extrusion. Other methods are of course possible and within the scope of the present disclosure.

In some embodiments it will be preferred to allow the cross section of the growing tray to be the same throughout the length of the growing tray. Specifically, in case of plastic (or possibly metal) extrusion this type of corresponding cross section throughout the total length of the growing tray allows for a simplified manufacturing process, this giving a possible to provide a competitive price for the end product.

In a possible embodiment of the present disclosure the growing tray comprises at least one end stop adapted to engage with a second and/or a first end of the growing tray. In such an embodiment it may be s preferred to use a stop at both the second and the first end of the tray. The end stop(s) further ensures that the water is evenly distributed over the total area of the tray, e.g. in case the tray is arranged flat on a surface. In a possible embodiment of the present disclosure it may be possible to adapt at least one of the end stops for allowing water to enter the tray in a desired manner (e.g. including a water intake), such as evenly across the width of the tray.

The growing tray is preferably provided as a component of a growth system for growing a crop, preferably being a hydroponic system, further comprising a cradle adapted to receive the plurality of growing trays, the cradle provided for horizontal arrangement of the growing trays, an irrigation arrangement including a water tank, the irrigation arrangement adapted to selectively supply water to the plurality of growing tray, and an illumination arrangement. It is of course preferred to use a plurality of trays in relation to the growth system. The expression “cradle” should in line with the present disclosure be interpreted broadly an may include any form of suspension or arrangement for holding the tray or a plurality of trays.

The growth system may further comprise at least one fan, at least one humidity sensor, and a control unit connected to the irrigation arrangement, the illumination arrangement, the fan and the humidity sensor, wherein the control unit is adapted to control the irrigation arrangement, the illumination arrangement and the fan based on a humidity value received from the humidity sensor and a predetermined growth scheme. Using such an implementation of the growth system may allow for a total control of when and how to water the crop as well as when to provide a suitable amount of light to the crop.

As mentioned above, the tray or trays within the growth system may possibly be slightly lengthwise inclined, i.e. where the first end of the tray may be arranged slightly higher as compared to the second end of the tray thus giving a desired lengthwise inclination of the tray. An overall lengthwise inclination may for example be selected to be in the range of 0.0-5.0 degrees, preferably in the range of 0.5-2.5 degrees. The level of lengthwise inclination may also be selected based on the type of crop to be grown at the tray.

The growth system may in some embodiments comprise a plurality of “levels”, resulting in a so called vertical growing system e.g. suitable for so called urban vertical farming.

Furthermore, the predetermined growth scheme may in some embodiments be dependent on the crop to be grown at the growth substrate provided at the plurality of growing trays. Such an implementation may possibly allow for an even higher yield, since different types of crops may need different amount of water and light form maximizing its yield.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 conceptually illustrates a growing tray according to the present disclosure provided with a growth substrate;

FIGS. 2A and 2B illustrates different trays in line with the present disclosure, each having different cross sections;

FIG. 3 shows an exemplary stack comprising a plurality of growing strays as shown in FIG. 1, and

FIG. 4 provides an example of a growth system according to the present disclosure comprising a plurality of trays as shown in FIG. 1.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

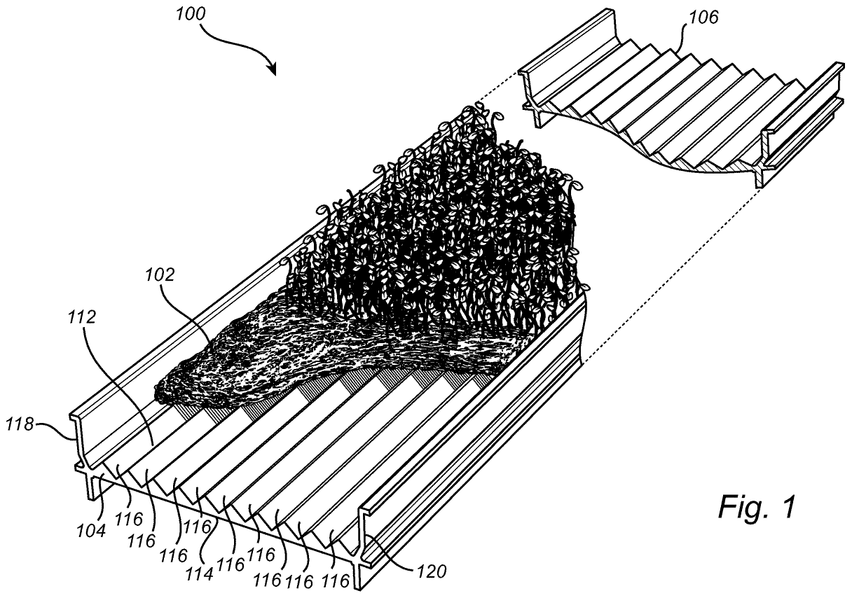

Referring now to the drawings and to FIG. 1 in particular, there is depicted an exemplary implementation of a growing tray 100 provided in line with the present disclosure. The growing tray 100 is in FIG. 1 shown to be provided with a growth substrate, here in the form of a fiber mat 102, such as a hemp math. Other types of growth substrates, such as soil, may as discussed above be used and are in line with the present disclosure. Onto the fiber mat 102 there has initially been provided a large plurality of seeds, in FIG. 1 shown to be in “microgreen stage” where the microgreen crop is approximately 2-3 centimeters tall. The growing tray 100 is here defined to have a first 104 and a second 106 end. The tray 100 may at each of the ends be optionally provided with end stops.

In some embodiments, the length of the growing tray 100 may be selected to be within the range of 0.5-2 m, and a width may be in a range of 8-20 cm. Other lengths and widths are of course possible and within the scope of the present disclosure.

The growing tray 100 further comprises an upwardly facing side 112 and a downwardly facing side 114. The upwardly facing side 112 is provided for receiving the fiber mat 102. A surface of the upwardly facing side 112 is further provided with a plurality of elongated independent channels 116, here shown to be extending along a full length of the tray 100. The plurality of channels 116 are furthermore here shown to be distributed equally across a width of the growing tray 100, the width being perpendicular to the length of the growing tray 100.

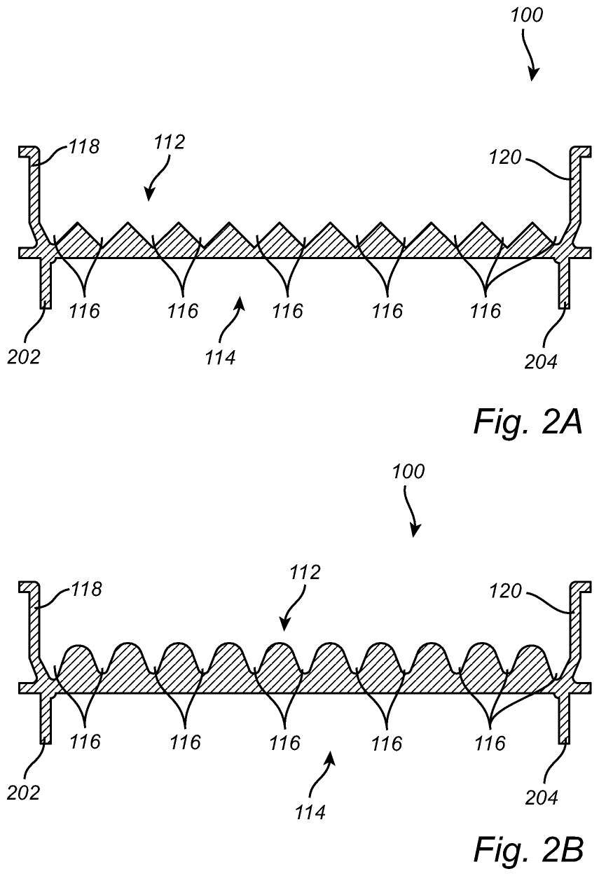

The plurality of elongated independent channels 116 at the surface of the upwardly facing side 112 are such arranged that there is a distinct vertical difference between a top and a bottom of the channels 116. In the illustration as shown and with further reference also to FIGS. 2A and 2B, a distance between top and the bottom is between 0.5-2 cm. It should however be understood that other selection of the distance may be used, e.g. dependent on the type of crop/microgreen/growth substrate used in relation to the tray 100.

As shown in FIG. 1, the growing tray 100 is furthermore provided with a pair of side walls 118, 120 extending along the length of the tray 100. The side walls 118, 120 may in some embodiments upwardly protrude less than 5 cm from the surface of the upwardly facing side 112.

In FIGS. 2A and 2B there are shown two possible embodiments of cross sections that may be use in relation to the growing tray 100. In FIG. 2A, growing tray 100 is shown where the plurality of elongated independent channels 116 at the surface of the upwardly facing side 112 are selected to have a triangular cross section. Correspondingly, in FIG. 2B the growing tray 100 is shown where the plurality of elongated independent channels 116 at the surface of the upwardly facing side 112 are selected to have a sinusoidal cross section. Each of these cross sections are such formed that in case water is poured or otherwise provided at the growing tray 100, the water will extend along the length of the growing tray 100. That is, water will not be allowed to “move crosswise” the growing tray 100, since the selected vertical top-to-bottom distance in combination with the shape of the channels 116 ensures that such water distribution is not possible (if not crosswise extending due to wetting the fiber mat 102). In one embodiment a vertical top-to-top distance is selected be essentially corresponding (0.5-1.5 of) the selected vertical top-to-bottom distance.

The growing tray 100 as exemplified in different ways in FIGS. 2A and 2B is provided with a downwardly facing side 114 being overall essentially flat. However, as shown in FIGS. 2A and 2B, the tray 100 is further provided with a pair of lengthwise extending downwardly facing protrusions 202, 204. The downwardly facing protrusions 202, 204 are in a preferred embodiment extending throughout a full length of the growing tray 100, giving the growing tray 100 the same cross section throughout the full length of the tray 100.

As is seen in FIGS. 2A and 2B, the pair of lengthwise extending downwardly facing protrusions 202, 204 are arranged slightly towards the center of the width of the growing tray 100, as compared to the pair of upwardly protruding side walls 118, 120. It may be suitable to arrange each of the lengthwise extending downwardly facing protrusions 202, 204 at least a thickness of the pair of upwardly protruding side walls 118, 120 towards the center of the growing tray 100, preferably slightly more.

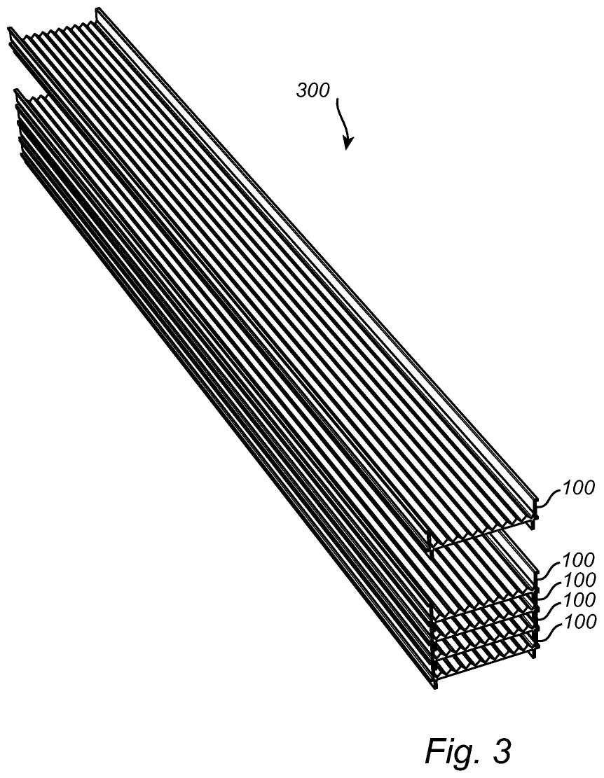

Accordingly, in case a plurality of growing tray 100 are arranged on top of each other they may form a stack 300, such as shown in FIG. 3. Such stacking allows for ease of handling and saves space when handling a large plurality of trays, e.g. in a growth preparation of the trays 100.

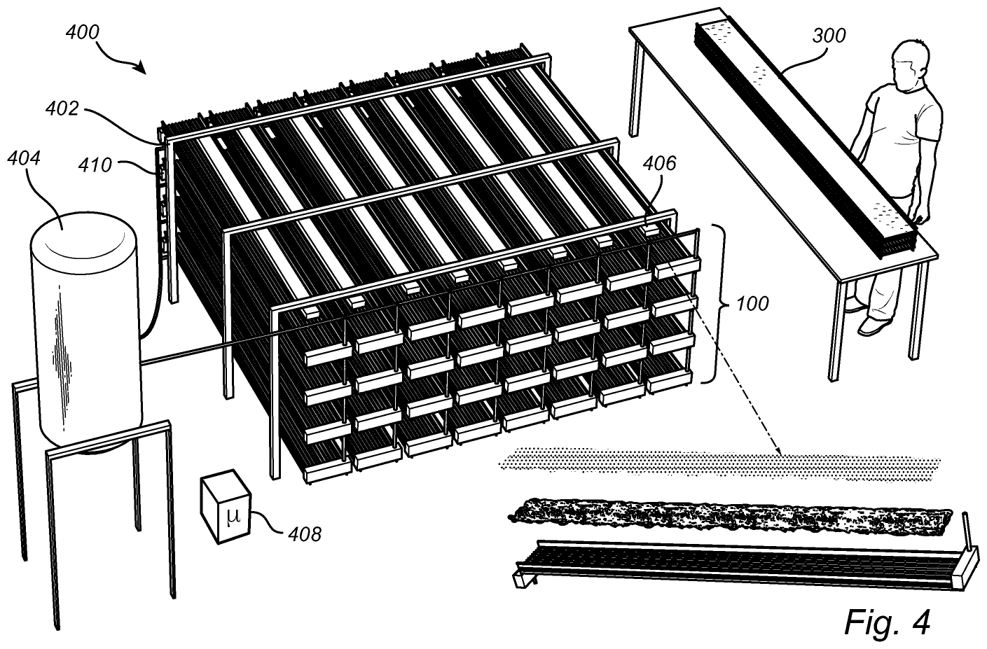

Turning finally to FIG. 4, conceptually illustrating a growth system 400 for growing a crop, such as microgreens, using a plurality of growing trays 100 according to the present disclosure. As shown in FIG. 4, the growth system 400 is shown to comprise four different “levels”, each provided with a plurality of growing tray 100. It should however be understood that any number of levels are possible (such as 1-100 or even more) and within the scope of the present disclosure.

The growing tray 100 are here shown to be arranged onto a cradle system 402 adapted to receive the plurality of trays 100. The growing tray 100 are here arranged essentially horizontally, however with the first end 104 slightly elevated in comparison to the second end 106, thus arranging the trays 100 slightly inclined. In some embodiments it may be possible to control the inclination, such as by allowing the elevation of the first end 104 to be adjustable. Such an adjustment could possibly allow for an overall inclination between 0.0-2.5 degrees. As understood, horizontal arrangement of growing tray 100 is not limited to arranging the growing tray 100 exactly lengthwise and crosswise horizontal.

The growth system 400 further comprises an irrigation arrangement including a water tank 404, an illumination arrangement e.g. including a plurality of light sources 406, at least one fan (not shown), at least one humidity sensor (not shown), and a control unit 408 connected to the irrigation arrangement, the illumination arrangement, the fan and the humidity sensor.

During operation of the growth system 400, water may be distributed from the water tank 404 and to each of the first ends 104 of the plurality of growing trays 100. Since the growing trays 100 are slightly inclined, the water will flow from the first 104 to the second 106 end of the growing trays and be received e.g. by a drainage arrangement 410 arranged such that any excess water pouring out from the second end 106 enters the drainage arrangement 410. The water will then, using pipes or similar, be returned to the water tank 404. It may in some optional embodiments be suitable to further include some form of water treatments means (not shown) for cleaning the “return water”.

The irrigation arrangement may further comprise at least one pump (not shown) that ensures that the water is flowing throughout the irrigation arrangement. The tank 404 as well as the pump may be arranged as suited for the explicit implementation at hand. The pump and further valves (not shown) are preferably controlled using the control unit 408, for example depending on a humidity level measured using the humidity sensor.

The control unit 408 is further arranged to control the light sources 406, for example dependent on predetermined growth scheme, where for example the predetermined growth scheme is dependent on the crop to be grown at the growth substrate provided at the plurality of trays 100. The predetermined growth scheme may in some embodiment be adjusted throughout a growth cycle for the crop.

For reference, the control unit 408 may in some embodiments for example be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

In FIG. 4, there is further illustrated a method for preparing a stack 300 of growing trays 100. The method includes providing a first growing tray 100, arranging a fiber mat 102 onto the first tray 100. Once the fiber mat 102 is in place, e.g. a person or a machine may be provided for arranging a large plurality of seeds onto the fiber mat 102.

Subsequently, the first tray 100 may be put to the to the side and the next growing tray 100 may be prepared. Once the next growing tray 100 has been prepared, it may be stacked onto the first growing tray 100, and the preparation process may continue. In some embodiments the stack of growing trays comprises two-10 growing trays.

Although the figures may show a sequence the order of the steps may differ from what is depicted. Also, two or more steps may be performed concurrently or with partial concurrence. Such variation will depend on the software for the mentioned control unit and hardware systems chosen and on designer choice. All such variations are within the scope of the disclosure. Likewise, software implementations in relation to the control unit could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art.

In addition, variations to the disclosed embodiments can be understood and effected by the skilled addressee in practicing the claimed present disclosure, from a study of the drawings, the disclosure, and the appended claims. Furthermore, in the claims, the word “comprising” does not exclude other elements or steps, and the indefinite article “a” or “an” does not exclude a plurality.

1. A growing tray for a growth system, the growing tray having an upwardly facing side and a downwardly facing side, wherein:
the growing tray has an elongated form extending along a length of the growing tray,
a surface of the upwardly facing side is provided with a plurality of elongated independent channels having an upward facing protruding triangular cross section extending along the length of the growing tray, and
the plurality of channels being distributed across a width of the growing tray, the width being perpendicular to the length of the growing tray,
wherein upward facing protruding portions of the plurality of elongated independent channels are adapted to receive a layer of a growth substrate.

2. The growing tray according to claim 1, wherein the channels extend along a full length of the growing tray.

3. The growing tray according to claim 1, wherein the channels are evenly distributed across the width of the growing tray.

4. The growing tray according to claim 1, wherein the channels have a distance between a top of the channels to a bottom of the channels that is within the range of 0.1-5 cm.

5. The growing tray according to claim 4, wherein the distance between the top and the bottom of the channels is selected depending on at least one of a crop to be grown at the growth substrate or a selected type of the growth substrate.

6. (canceled)

7. The growing tray according to claim 1, wherein the cross section of the growing tray is the same throughout the length of the growing tray.

8. The growing tray according to claim 1, further comprising a pair of side walls extending along the length of the growing tray.

9. The growing tray according to claim 8, wherein the side walls upwardly protrude less than 5 cm from the surface of the upwardly facing side.

10. The growing tray according to claim 1, wherein the downwardly facing side is essentially flat.

11. The growing tray according to claim 1, wherein the width of the growing tray is less than a fifth of the length of the growing tray.

12. The growing tray according to claim 1, wherein the width of the growing tray is in a range of 8-20 cm.

13. (canceled)

14. The growing tray according to claim 1, wherein the growth system is a hydroponic system and the growth substrate is a fiber mat.

15. The growing tray according to claim 14, wherein the fiber mat is a single fiber mat covering a total growth area of the growing tray.

16. (canceled)

17. The growing tray according to claim 1, wherein the growth substrate is adapted for growth of microgreens.

18. The growing tray according to claim 1, wherein the growing tray is manufactured from a plastic material.

19. The growing tray according to claim 1, wherein the growing tray is manufactured using injection molding or plastic extrusion.

20. The growing tray according to claim 1, wherein the growing tray comprises at least one end stop adapted to engage with a second or a first end of the growing tray.

21. A growth system for growing a crop, comprising:
a plurality of growing trays according to claim 1, each provided with a growth substrate,
a cradle adapted to receive the plurality of growing trays, the cradle provided for horizontal arrangement of the growing trays,
an irrigation arrangement including a water tank, the irrigation arrangement adapted to selectively supply water to the plurality of growing tray, and
an illumination arrangement.

22. The growth system according to claim 21, further comprising:
at least one fan,
at least one humidity sensor, and
a control unit connected to the irrigation arrangement, the illumination arrangement, the fan and the humidity sensor,
wherein the control unit is adapted to control the irrigation arrangement, the illumination arrangement and the fan based on a humidity value received from the humidity sensor and a predetermined growth scheme.

23. The growth system according to claim 21, wherein the predetermined growth scheme is dependent on the crop to be grown at the growth substrate provided at the plurality of growing trays.
